(19) United States
(12) Patent Application Publication
(10) Pub. No.: US 2005/0092474 A1
(43) Pub. Date: May 5, 2005

(54) Method for forming a heat exchanger stack

(76) Inventor: Pessach Seidel, Motza Ilit (IL)

Correspondence Address: NIXON & VANDERHYE, PC, 1100 N GLEBE ROAD, 8TH FLOOR, ARLINGTON, VA, 22201-4714, US

(21) Appl. No.: 10/779,689

(22) Filed: Feb. 18, 2004

(30) Foreign Application Priority Data
Oct. 31, 2003 (IL) 158705

(51) Int. Cl. F28F 7/00

(52) U.S. Cl. 165/166

(57) ABSTRACT

A heat exchanger stack includes two or more nestable plates formed of a plate material being substantially unresponsive to electromagnetic impulse welding, and wherein each plate includes a generally flat central portion having a plurality of protrusions protruding from one or more surfaces thereof and one or more pairs of edge portions generally formed non-coplanar relative to the generally flat central portion. The two or more plates are arranged in a nesting arrangement and spaced apart by the protrusions so as to define therebetween a space through which a heat exchange medium may flow. Further, two or more plates are affixed together by electromagnetic pulse welds at a plurality of welding locations which include the protrusions and one or more pairs of edge portions. Also, the two or more plates are mutually connected at the welding locations via a facilitator substrate, which is highly responsive to electromagnetic impulse welding, and which is disposed on one or more of the two plates.

### FIELD OF THE INVENTION

The present invention relates, generally to heat exchangers and, more specifically, to forming a stack of heat exchanger plates.

### GLOSSARY

### Facilitating Substrate

An applied coating, layer or covering of material substantially responsive to applied electromagnetic impulse energy for application to a surface of an object substantially unresponsive to electromagnetic impulse energy, thereby to effectively provide the object with substantial responsiveness to electromagnetic impulse energy.

### BACKGROUND OF THE INVENTION

It is known in the art to provide for forming a stack of heat exchanger plates which are welded together using a high energy, short duration electro-magnetic pulse.

With reference to U.S. Pat. No. 6,513,240 dated Feb. 4, 2003 entitled “Method of forming a heat exchanger stack” to Pessach Seidel, who is also the inventor of the present invention, there is described a method for forming a heat exchanger stack from a plurality of plates. The plurality of plates includes at least first and second nestable plates formed of an electrically conductive material. Each plate has a generally flat central portion and at least one pair of edge portions generally non-coplanar relative to the respective central portions of the plates. Each plate has a plurality of protrusions, which are formed so that, when the plates are in a stacked, nested position, the respective pluralities of protrusions of the first and second plates engage each other. In addition, the respective central portions of the plates are spaced apart, thereby to define therebetween a space through which a heat exchange medium may be passed. The method includes placing the first heat exchanging plate on a support, placing the second heat exchanging plate in nesting arrangement with the first heat exchanging plate such that the central portions and the edge portions of the two plates are spaced apart, and exposing at least the edge portions of the second heat exchanging plate to pulsed electromagnetic energy, so as to apply thereto a kinetic force causing the edge portions to bend away from the pulsed electromagnetic energy source, such that they impinge on the respective edge portions of the first plate, so as to become joined thereto.

With reference to FIG. 1, there is shown in accordance with the prior art U.S. Pat. No. 6,513,240 a lower static plate referenced 10 having down-turned edges referenced 14 and 16 positioned on a supporting base referenced 2. If plate 10 is formed of a thick material, the support of base 2 is not required.

A second plate referenced 20 usually formed having a similar shape to plate 10, formed having two down-turned edges referenced 24 and 26, is positioned over plate 10. Plate 10 and plate 20 are designed so that gaps formed therebetween may be varied according to the welding requirement.

There is formed a region between plates 10 and 20 that provides turbulent flow of fluid passing therethrough causing high heat transfer, this area including protrusions referenced 18 and 28 respectively.

Due to the application of electro-magnetic impulses by an electromagnetic pulse welding source referenced 33, upper plate 20 is projected as indicated by arrow referenced 30 and 32 against lower plate 10, causing a change of shape of edges 24 and 26 respectively, inducing an electromagnetic weld in areas referenced 34 and 36. Between protrusions 18 and 28 a weld is similarly formed by electromagnetic impulses projected as indicated by arrow referenced 38.

The drawback to the prior art invention is that, while the weld is formed between protrusions 18 and 28, there is the lack of internal support within flow area between areas referenced 12 and 22 respectively of plates 10 and 20. The entire surface area 12 becomes projected towards area 22, not merely in the vicinity of protrusions 18 and 28, thereby causing distortion of the shape of areas 12 and 22.

Referring now to FIGS. 2 and 3 there are seen views according to another embodiment of the prior art, showing the welding impulse process applied from the concave side of similar shaped plates referenced 40 and 50 as opposed to that indicated in FIG. 1. In FIG. 2, there is seen preformed plate 40 disposed on base referenced 4 and plate 50 is positioned over plate 40. Plates 40 and 50 are formed having turned-up edges referenced 44 and 46 and 54, and 56 respectively. Plate 50 is so disposed relative to plate 40 so as to provide an acceleration gap therebetween.

In FIG. 3, there is shown the disposition of plates 40 and 50 after electromagnetic impulse welding using source referenced 53 as indicated by arrows referenced 51 and 49. Edge 54 is projected towards edge 44, creating a welded area referenced 55 therebetween and edge 56 is projected towards edge 46 creating welded area referenced 57 therebetween. The flow region between plate areas referenced 42 and 52 are similarly welded together utilizing electromagnetic impulse source 53 directing impulses as indicated by arrow referenced 58 at protrusions 48 and 58. However, during this welding process there occurs distortion of plates 40 and 50 in areas referenced 42 and 52 respectively.

According to another embodiment of the prior art, referring now to FIG. 4, there is shown the disposition onto base referenced 8 of lower plate 60 and upper plate 70 on the left side of FIG. 4 referenced 71 prior to welding and on the right side referenced 79, after welding. Plates 60 and 70 are formed having a pair of edges 64 and 66 and 74, and 76 respectively. There is further shown the welding impulse process applied from source 73 as indicated by arrows 80 and 82 to the convex, upper surface of edges 74 and 76 of plate 70 causing edges 74 and 76 to be projected towards edges 64 and 66 respectively, thereby to provide welding therebetween. Also, electromagnetic impulses are applied from source 77 as indicated by arrows 88 to the concave, lower side of plate 60 as opposed to that indicated in FIG. 1. Plate 60 is projected towards plate 70 thereby causing protrusions referenced 68 to impinge against opposing protrusions 78 and thereby providing welding therebetween.

There arises a problem in regard to the above prior art embodiment, however, in so far as severe distortion is found to occur to plates 60 and 70.

Furthermore, the above-mentioned process is efficient for heat exchanger plates made from highly conductive metals such as copper, aluminum, magnesium, etc. Materials that are not good conductors, such as tin, steel, stainless steel, titanium, etc., require the application of additional force or energy.

### SUMMARY OF THE INVENTION

The present invention aims to provide a heat exchanger stack in accordance with a preferred embodiment of the present invention, including two or more nestable plates formed of a plate material being substantially unresponsive to electromagnetic impulse welding, and wherein each said plate includes a generally flat central portion having a plurality of protrusions protruding from one or more surfaces thereof and one or more pairs of edge portions generally formed non-coplanar relative to the generally flat central portion. The two or more plates are arranged in a nesting arrangement and spaced apart by the protrusions so as to define therebetween a space through which a heat exchange medium may flow. Further, two or more plates are affixed together by electromagnetic pulse welds at a plurality of welding locations which include the protrusions and one or more pairs of edge portions. Also, the two or more plates are mutually connected at the welding locations via a facilitator substrate, which is highly responsive to electromagnetic impulse welding, and which is disposed on one or more of the two plates.

In accordance with an embodiment of the present invention, the facilitator substrate is selectively applied to one or more surfaces of the edge portions of one of the two or more nestable plates.

In accordance with another embodiment of the present invention, the facilitator substrate is selectively applied to one or more surfaces of the protrusions of two or more nestable plates.

In accordance with a further embodiment of the present invention, a substrate of a non-conductive material is selectively applied to one surface of the edge portions and to the generally flat central portion of one or more of the two or more nestable plates, thereby to provide resistance to electromagnetic impulse welding thereto.

The present invention aims to provide a heat exchanger stack in accordance with another preferred embodiment of the present invention, including two or more nestable plates formed of a plate material being substantially unresponsive to electromagnetic impulse welding, and wherein each said plate includes a generally flat central portion having a plurality of protrusions protruding from one or more surfaces thereof and one or more pairs of edge portions generally formed non-coplanar relative to the generally flat central portion. The two or more plates are arranged in a nesting arrangement and spaced apart by the protrusions so as to define therebetween a space through which a heat exchange medium may flow. Further, two or more plates are affixed together by electromagnetic pulse welds at a plurality of welding locations which include the protrusions and one or more pairs of edge portions. Also, the two or more plates are mutually connected at the welding locations via an intervening facilitator material, which is highly responsive to electromagnetic impulse welding.

In accordance with another embodiment of the present invention, the intervening facilitator material provides a joining medium in said plurality of welding locations.

The present invention further aims to provide a method for causing a welding process by the application of a electromagnetic pulse from an electrical source thereto, so as to provide a thrust to preselected portions of a heat exchanger plate, fabricated from materials that are relatively poor electrical conductors or even non-conductors. The preselected portions become welded to an adjacent fixed heat exchanger plate. In order to accelerate the thrust created by the electromagnetic pulse, a thin layer of a facilitating substrate material such as copper, certain plastics and aluminum) is selectively applied in the preselected area to be welded, either in front of or behind the heat exchanger plate. This film is activated by the electromagnetic pulse and serves to respectively pull or push the “dynamic” plate towards its stationary partner, thereby creating a weld.

In the context of the present invention, the “dynamic” heat exchanger plate relates to that heat exchanger plate which is accelerated and caused to impact or impinge against an adjacent static or fixed plate by the application of an electromagnetic impulse thereto There is provided a method of forming a heat exchanger stack from a plurality of preformed heat exchanger plates, wherein the plurality of plates includes two or more nestable plates, each having a generally flat central portion and having one or more a pairs of edge portions generally non-coplanar relative to the respective central portion of the plate. Also, each plate is formed so that, when the plates are in a stacked, nested position, the respective central portions of the plates, having similar protrusions formed on both surfaces of the central portions of the plates, are spaced apart thereby to define therebetween a space through which a heat exchange medium may be passed. The method includes the steps of
a) applying a facilitator substrate, which is highly responsive to electromagnetic impulse welding, to at least one surface of the edge portions and selectively to at least one surface of the generally flat central portion of each plate;
b) disposing the first and second exchanger plates in nesting arrangement on a support; such that the central portions and the edge portions of the two plates are spaced apart; and
c) exposing the facilitator substrate applied to one or more of the first and second heat exchanger plates to a source of electromagnetic impulse energy, so as to apply thereto a kinetic force causing the facilitator substrate to induce the edge portions and selected portions of the flat central portion to bend away from the source of electromagnetic impulse energy, such that the edge portions and the protrusions impinge on the respective edge portions and protrusions of the other plate, so as to become joined thereto.

There is provided another method for forming a heat exchanger stack from a plurality of plates, wherein the plurality of plates includes two or more nestable plates, each having a generally flat central portion and one or more pairs of edge portions generally non-coplanar relative to the central portion of the plate. Each plate has a plurality of protrusions which is formed so that, when the plates are in a stacked, nested position, the respective opposing pluralities of protrusions of the first and second plates are disposed in close spaced apart proximity to each other, and that the respective central portions of the plates are spaced apart, thereby to define therebetween a space through which a heat exchange medium may be passed. The method includes the steps of
a) applying a facilitator substrate, which is highly responsive to electromagnetic impulse welding, to at least one surface of the edge portions of each plate and to preselected portions adjacent to the protrusions of the generally flat central portions of each plate;
b) disposing the first and second exchanger plates in nesting arrangement on a support; such that the central portions and the edge portions of the two plates are spaced apart; and
c) exposing the facilitator substrate applied to at least one of the first and second heat exchanger plates to a source of electromagnetic impulse energy, so as to apply thereto a kinetic force causing the facilitator substrate to induce the edge portions and selected portions of the flat central portion to bend away from the source of electromagnetic impulse energy, such that the edge portions and the protrusions impinge on the respective edge portions and protrusions of the other plate, so as to become joined thereto.

In accordance with an embodiment of the present invention the method step of placing the first heat exchanger plate on a support includes placing it in supporting contact with a shaped surface defined by the support.

There is provided a further method for forming a heat exchanger stack from a plurality of plates, wherein the plurality of plates includes two or more nestable plates, each having a generally flat central portion and one or more pairs of edge portions generally non-coplanar relative to the central portion of the plate. Each plate has a plurality of protrusions which is formed so that, when the plates are in a stacked, nested position, the respective opposing pluralities of protrusions of the first and second plates are disposed in close spaced apart proximity to each other, and that the respective central portions of the plates are spaced apart, thereby to define therebetween a space through which a heat exchange medium may be passed. The method includes the steps of
a) applying a facilitator material, which is highly responsive to electromagnetic impulse welding, to at least one surface of the edge portions and selectively to at least one surface of the generally flat central portion of each plate;
b) disposing the first and second exchanger plates in nesting arrangement on a support; such that the central portions and the edge portions of the two plates are spaced apart; and
c) exposing the facilitator applied to at least one of the first and second heat exchanger plates to a source of electromagnetic impulse energy, so as to apply thereto a kinetic force causing the facilitator material to induce the edge portions and selected portions of the flat central portion to bend away from the source of electromagnetic impulse energy, such that the edge portions and the protrusions impinge on the respective edge portions and protrusions of the other plate, so as to become joined thereto by the intervening facilitator material.

### BRIEF DESCRIPTION OF THE DRAWINGS

The present invention will be more fully understood and its features and advantages will become apparent to those skilled in the art by reference to the ensuing description, taken in conjunction with the accompanying drawings, in which:

FIG. 1 is a schematic cross-sectional view of a convex stack of heat exchanger plates in accordance with the PRIOR ART;

FIGS. 2 and 3 are schematic cross-sectional views of a concave stack of heat exchanger plates in accordance with the PRIOR ART;

FIG. 4 is a schematic cross-sectional view of a convex stack of heat exchanger plates having an electromagnetic impulse applied from beneath the stack in accordance with the PRIOR ART;

FIG. 5 is a schematic cross-sectional view of a convex stack of heat exchanger plates prior to and subsequent to electromagnetic impulse welding in accordance with a preferred embodiment of the present invention;

FIG. 6 is a schematic cross-sectional view of a convex stack of heat exchanger plates prior to and subsequent to electromagnetic impulse welding in accordance with an embodiment of the present invention;

FIG. 7 is a schematic cross-sectional view of a convex stack of heat exchanger plates prior to and subsequent to electromagnetic impulse welding in accordance with another embodiment of the present invention;

FIG. 8 is a schematic cross-sectional view of a convex stack of heat exchanger plates prior to and subsequent to electromagnetic impulse welding in accordance with a further embodiment of the present invention;

FIGS. 9 and 10 are schematic cross-sectional views of a concave stack of heat exchanger plates respectively prior to and subsequent to electromagnetic impulse welding in accordance with an embodiment of the present invention;

FIGS. 11 and 12 are schematic cross-sectional views of a concave stack of heat exchanger plates respectively prior to and subsequent to electromagnetic impulse welding in accordance with an embodiment of the present invention;

FIGS. 13 and 14 are schematic cross-sectional views of a concave stack of heat exchanger plates respectively prior to and subsequent to electromagnetic impulse welding in accordance with an embodiment of the present invention;

FIG. 15 is a schematic cross-sectional view of a convex stack of heat exchanger plates having an electromagnetic impulse applied from beneath the stack; and

FIG. 16 is a schematic cross-sectional view of a convex stack of multiple heat exchanger plates.

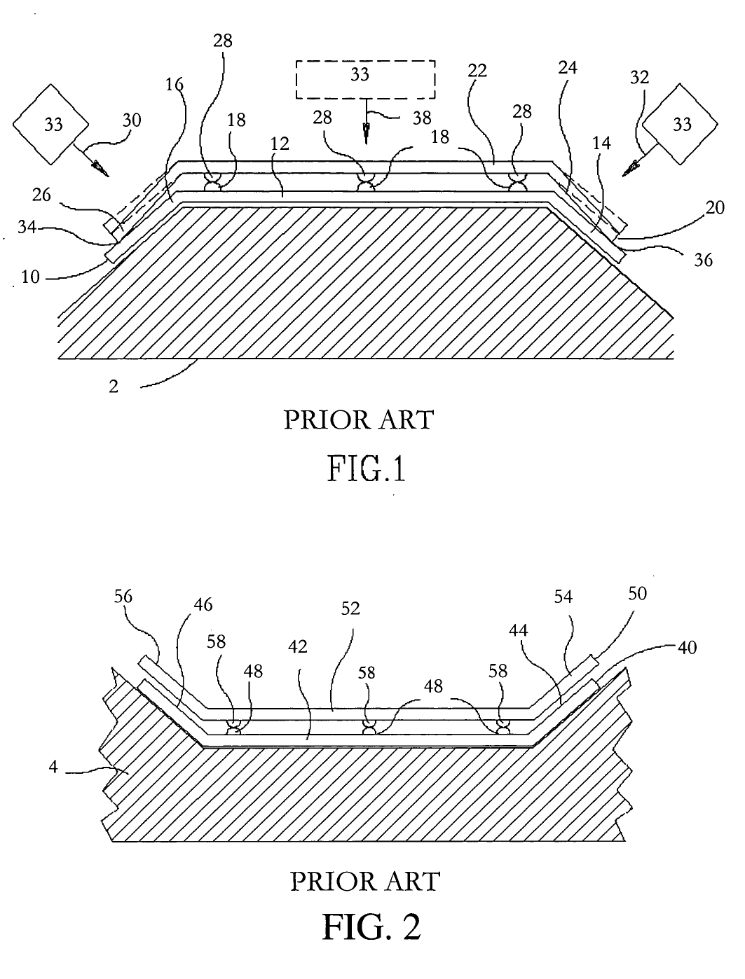

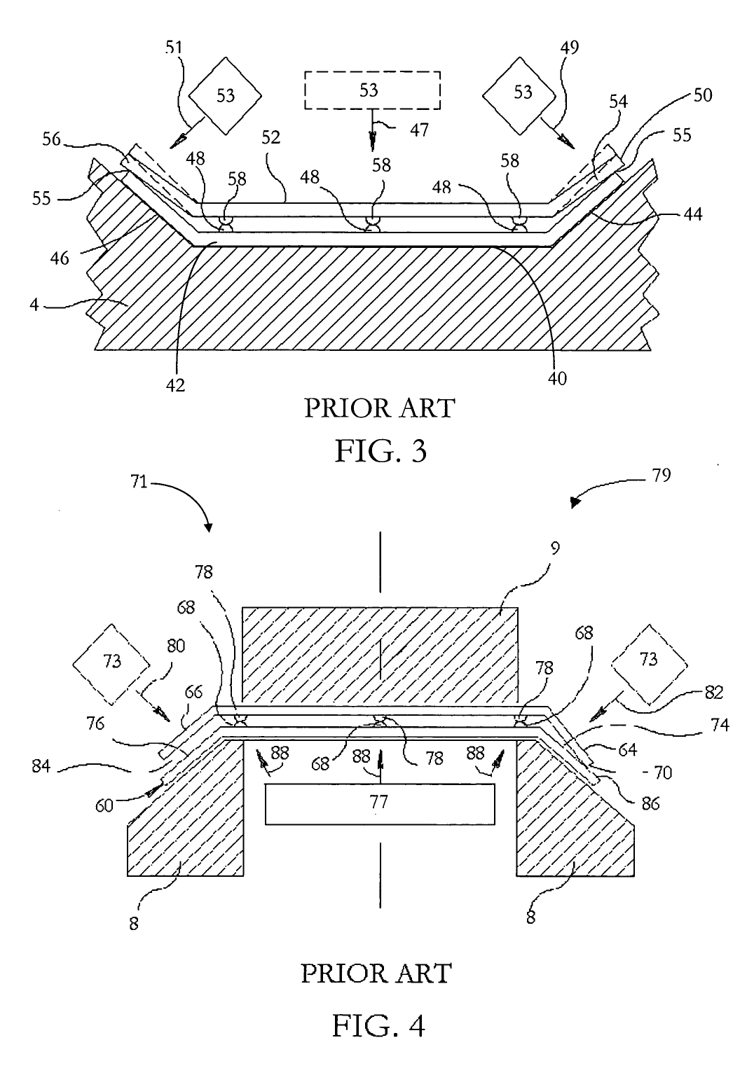

### DETAILED DESCRIPTION OF THE INVENTION

The present invention discloses a means for facilitating electromagnetic impulse welding of a stack of heat exchanger plates together wherein the heat exchanger plates are formed from less conductive or even non-conductive materials which are substantially unresponsive to electromagnetic impulse welding, while reducing or preventing distortion of the plates.

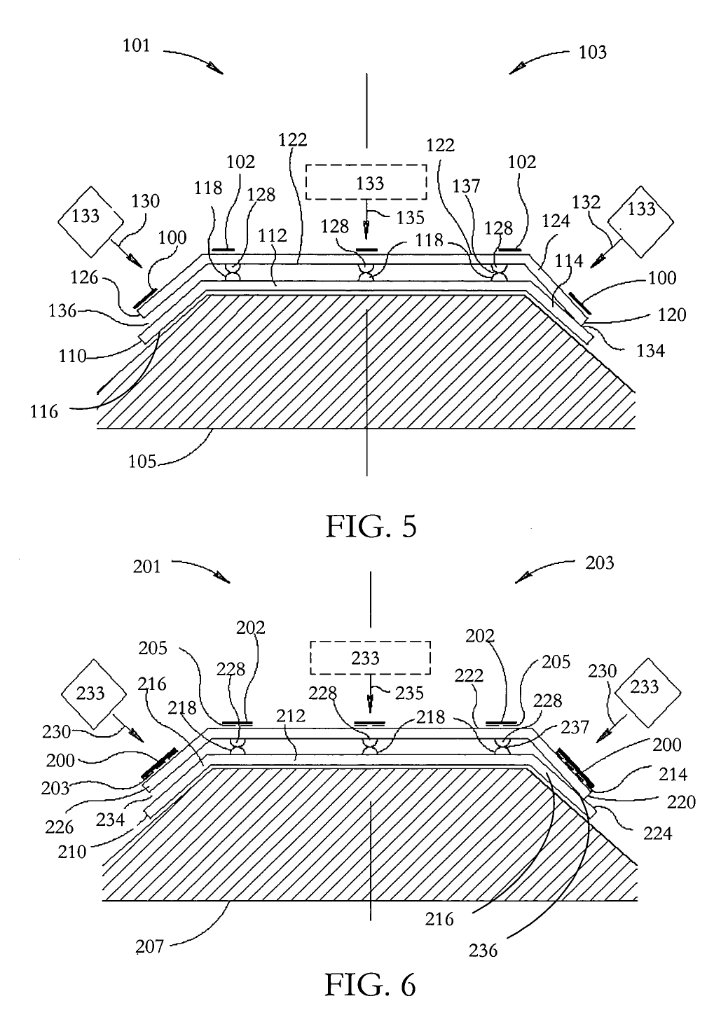

Referring now to FIG. 5, there is illustrated an application in accordance with a preferred embodiment of the present invention. On the left side generally referenced 101 of FIG. 5, there is shown the disposition onto base 105 of lower plate 110 and upper plate 120 before welding and on the right, generally referenced 103, after welding. Prior to welding, there is an acceleration gap provided between opposing protrusions referenced 118 and 128. In addition, as an improvement to what is disclosed in the prior art U.S. Pat. No. 6,513,240, facilitating substrates referenced 100, which are substantially more responsive to an applied electro-magnetic field, are applied to upper surfaces of edges referenced 124 and 126 and similar facilitating substrates, referenced 102 are applied to upper surface of plate 120, adjacent to protrusions 128.

An electro-magnetic pulse is applied from electromagnetic source 133, as indicated by arrows referenced 130 and 132 to each film area 100, and as indicated by the arrow referenced 135, to each film area referenced 102 thereby causing a kinetic projection of edges 124 and 126 and protrusions 128 of upper plate 120 to impinge against lower plate 110. Consequently weld referenced 134 is formed between edges 114 and 124, and weld referenced 136 is formed between edges 116 and 126, and weld referenced 137 between protrusions 118 and 128.

To facilitate appropriate eddy currents so as to apply impulses to facilitating substrate material disposed on parts to be welded, these facilitating substrates require to be conductively connected to each other (not shown).

After welding the initial stack of two plates 110 and 120, a further plate (not shown) is positioned thereover. Welding of edges and protrusions is then carried out as disclosed herein above.

Referring now to FIG. 6 there is shown, before welding on the left side generally referenced 201 and on the right, generally referenced 209, after welding, the disposition onto base 207 of lower plate referenced 210 and upper plate 220. There is seen a pushing facilitating substrates referenced 202 and a separating substrates referenced 203 disposed along the upper surface of edges referenced 224 and 226. Similarly, pushing facilitating substrates 202 and separating substrates 205 are disposed on surface referenced 222 of plate 220 adjacent to protrusions referenced 228. Separating substrates 203 are formed of a material that facilitates transfer of force from facilitating substrates 200 and 202 towards edges 224 and 226 and surface 222 respectively but prevents welding from occurring therebetween. There is shown on the left side 201 of FIG. 6 the disposition of lower plate 210 and upper plate 220 before welding and on the right side 203, after welding. After application of an electromagnetic pulse from source referenced 233 as indicated by arrows referenced 230 and 232, edges 224 and 226 are projected by pusher film 200 and separating film 203 towards edges 214 and 216, respectively. Welding occurs in areas referenced 234 and 236. In addition, welding together of protrusions 218 and 228 in area 222 is facilitated by projecting pushing film 202 and separating film 205 by application of electromagnetic impulses from source referenced 233 in the direction of arrow referenced 235.

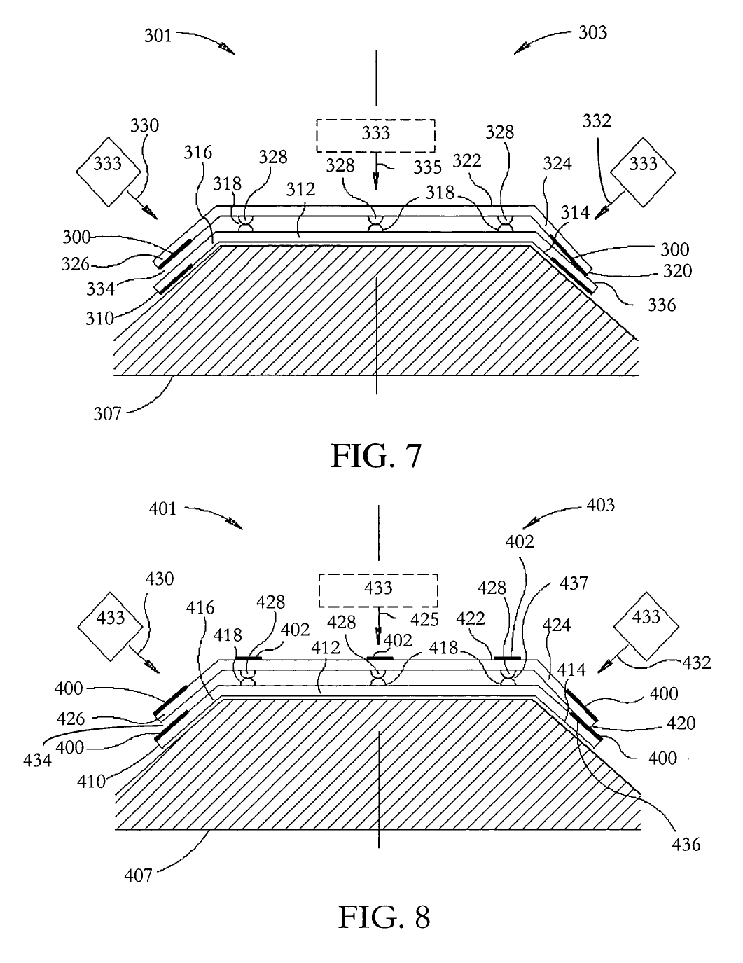

Referring now to FIG. 7 there is shown the disposition onto base 307 of lower plate 310 and upper plate 320 before welding on the left side referenced 301 and on the right side referenced 303, after welding. Plates 310 and 320 are provided with a selective area of a facilitating substrate, which is substantially responsive to an electromagnetic impulse. Facilitating substrates referenced 300 are disposed on the under-side of edge areas referenced 324 and 326 respectively, and also on edge areas referenced 314 and 316, respectively, in preparation for welding. In area 312 there is a facilitating substrate (not shown) on protrusions 328 formed in area 322. Following application of an electromagnetic impulse from sources referenced 333 as indicated by arrows referenced 330 and 332, facilitating substrates 300 are projected towards stationary edges 314 and 316 and, in so doing, pull dynamic plate edges 324 and 326 against static edges 314 and 316, respectively, thereby creating welding therebetween at areas referenced 334 and 336, as shown on right side 303. Similarly, electromagnetic pulses are projected from source 333 in the direction of arrow referenced 335 so that facilitating substrate materials on protrusions 328 are projected towards protrusions 318, and, in so doing, pull protrusions 328 against protrusions 318, and thereby creating welding therebetween.

Referring now to FIG. 8 there is shown a lower plate referenced 410 and upper plate referenced 420 before welding on the left side referenced 401 and, after welding, on the right side referenced 403 disposed onto base referenced 407. Facilitating substrate 400 is disposed on the external, convex side of both pairs of edges referenced 414 and 416 and 424 and 426 of plates 410 and 420 respectively. Similarly, Facilitating substrate referenced 402 is disposed on the external, convex side of both areas referenced 412 and 422 adjacent and over protrusions referenced 418 and 428. Directing electromagnetic impulses from source referenced 433 as indicated by arrows referenced 430 and 432 causes facilitating substrate 400 and associated edges 424 and 426 to be projected towards edges 414 and 416 and to be welded thereto incorporating facilitating substrate 400 thereon into the welded areas referenced 434 and 436 respectively. Similarly, directing electromagnetic impulses from source 433 as indicated by arrow 425, facilitating substrate material 402 projects protrusions 428 on surface 422 towards protrusions 418, coated with facilitating substrate material, on surface 412 to form welds referenced 437 therebetween incorporating the facilitating substrate material therein.

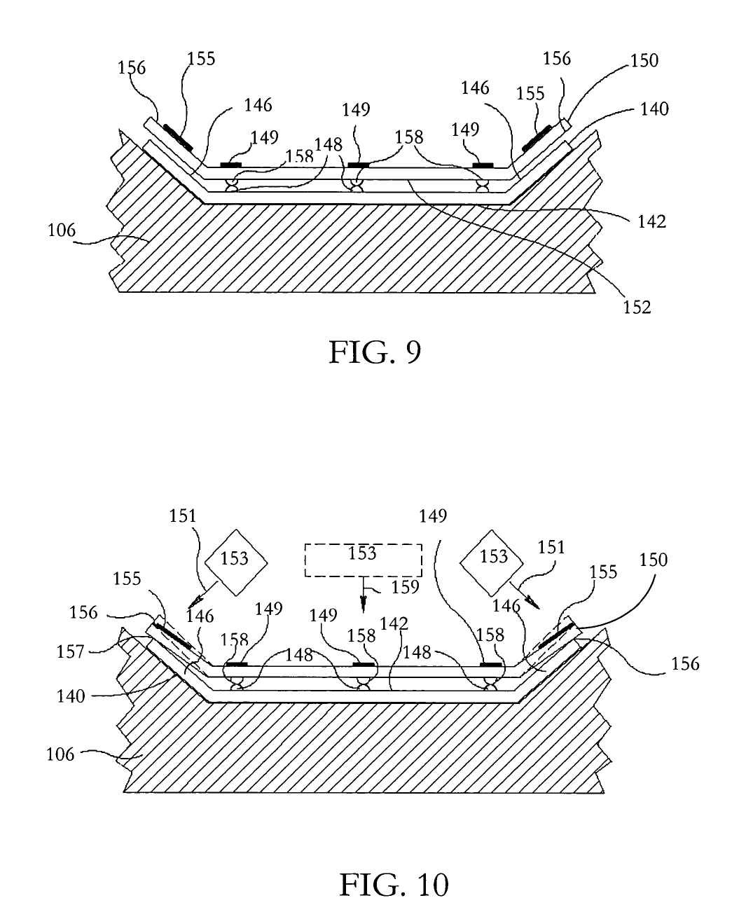

In accordance with another embodiment of the present invention, referring now to FIGS. 9 and 10, concave heat exchanger plates referenced 140 and 150 are nestingly disposed on concave base referenced 106. A facilitating substrate referenced 155 is disposed on the concave edge areas referenced 156 of plate 140 and facilitating substrate referenced 149 is disposed on the concave surface in area referenced 152 adjacent to protrusions referenced 158. As seen in FIG. 10, with application of an electromagnetic impulse from source referenced 153 as indicated by arrows referenced 151, facilitating substrates 155 are projected towards areas 156 of static plate 140. In so doing, areas 156 of plate 150 are respectively projected towards areas 146 of plate 140 thereby to provide welds therebetween. In FIG. 10 there is shown the disposition of edges 114 and 116 after application of electromagnetic impulses from source 153 as directed by arrow referenced 159 to facilitating substrates 149 thereby to cause welding between opposing protrusions 148 and 158 formed respectively in areas referenced 142 and 152.

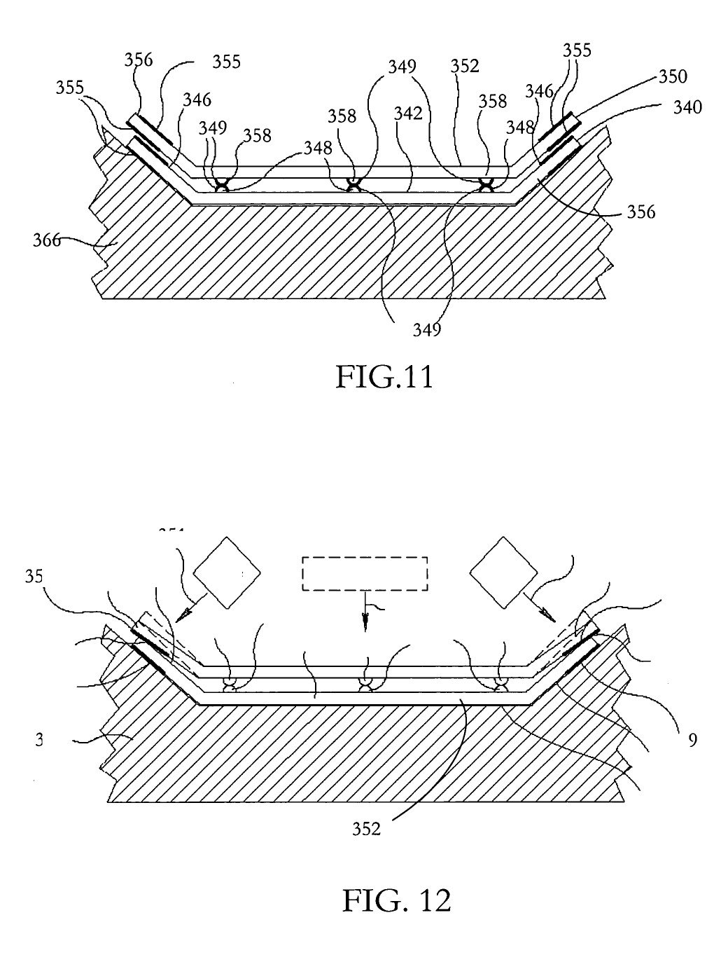

Referring now to FIGS. 11 and 12, similar heat exchanger plates referenced 340 and 350 are nestingly disposed in base referenced 366. In accordance with a further embodiment of the present invention, relating to a facilitating substrate material both facilitating and forming welds between nested plates 340 and 350, intermediate facilitating substrate material referenced 355 is disposed on plates 340 and 350 on both surfaces of edges referenced 346 and 356 and, also, over and adjacent to protrusions referenced 348 and 358 formed in areas referenced 342 and 352, where welding is required.

In FIG. 12, with application of electromagnetic impulses from source referenced 353 as indicated by arrows referenced 351 and 352, facilitating substrate materials 359 is seen to pull and project edges 356 towards edges 346, thereby welding therebetween referenced 355 with facilitating substrate material 359. Similarly, with application of electromagnetic impulses as indicated by arrow referenced 361 from source 353, facilitating substrate material 349, as indicated in FIG. 11, is seen to pull and project protrusions referenced 358 towards opposing protrusions referenced 348, thereby welding therebetween with facilitating substrate material 349.

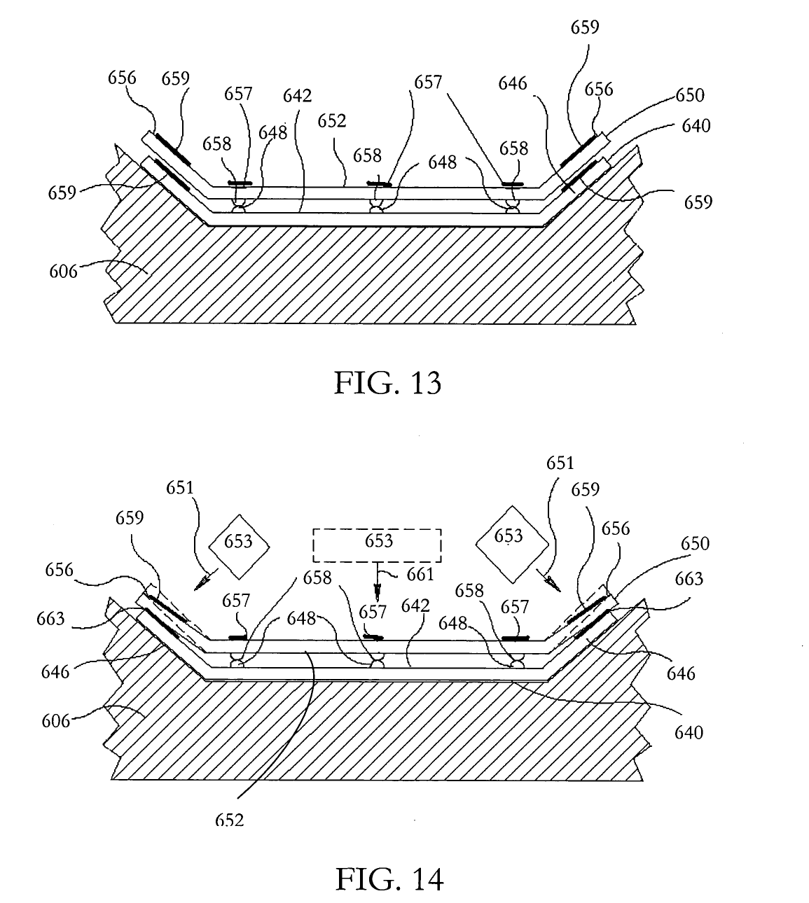

In accordance with an alternative embodiment of the present invention, relating to a facilitating substrate material applied onto a single surface both facilitating and actively forming the welds between nested plates, reference is now made to FIGS. 13 and 14. In FIG. 13, similar heat exchanger plates referenced 640 and 650 are nestingly disposed in base referenced 606. Only the upper surfaces of edges referenced 646 and 656 of both plates 640 and 650 receive a facilitating substrate material referenced 659 and areas referenced 642 and 652 adjacent to protrusions referenced 648 and 658 receive a facilitating substrate material referenced 657 only on the upper surface thereof. In FIG. 14, with application of electromagnetic impulses as indicated by arrows referenced 651 and 652 from source referenced 653, facilitating substrate materials referenced 654 push and project edges referenced 656 towards edges referenced 646, thereby causing welding therebetween at areas referenced 658 with intermediate facilitating substrate material 659. With application of electromagnetic impulses as indicated by arrow referenced 661 from source 653, facilitating substrate material (not shown) on the upper surface of areas referenced 642 and 652 adjacent to protrusions referenced 648 and 658, respectively, is seen to push and project protrusions 658 towards opposing protrusions 648, thereby welding therebetween with facilitating substrate material (not shown) disposed on protrusions 648.

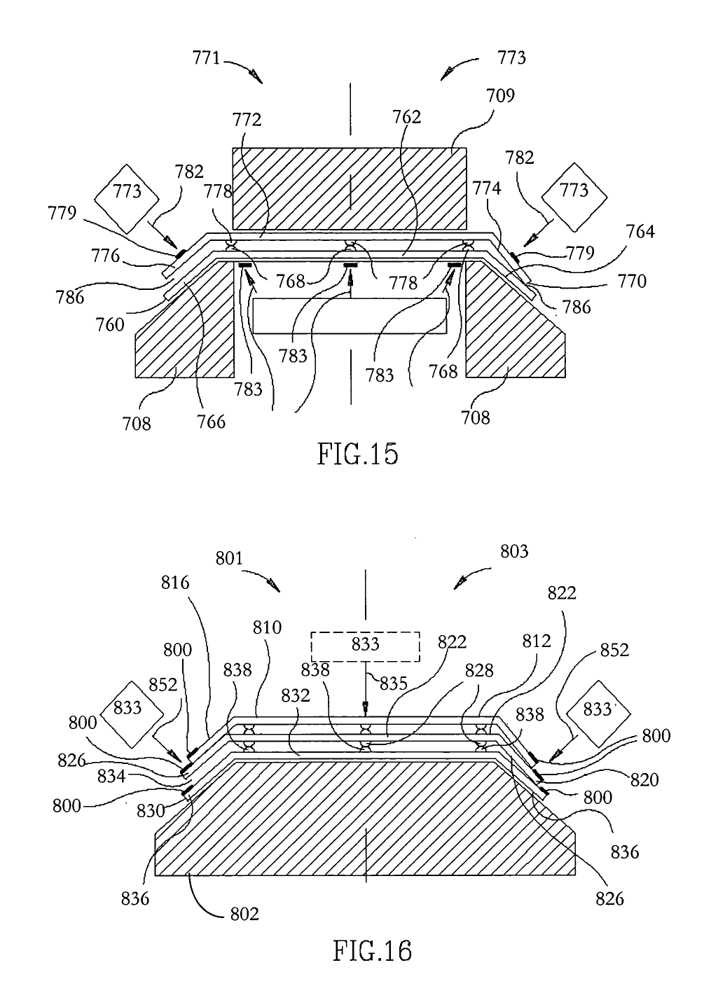

Referring now to FIG. 15, in accordance with an added embodiment of the present invention, there is shown lower plate referenced 760 and upper plate referenced 770 disposed onto base referenced 708 such that the left side referenced 771 of FIG. 15 indicates the status before welding and the right side referenced 773, after welding. There is illustrated facilitating welding of edges referenced 774 and 776 of plate 770 respectively to edges referenced 764 and 766 of plate 760, and of protrusions referenced 778 to opposing protrusions referenced 768, either simultaneously or separately. This is facilitated by applying a facilitating substrate material referenced 779 to the upper surface of edges 774 and 776 of plate 770 and by applying a facilitating substrate material 783 to the lower surface of area referenced 762. Electromagnetic pulse source referenced 773 acts as indicated by arrows referenced 780 and 782 on facilitating substrate referenced 779 on edges 774 and 776, which are projected, respectively, towards edges 764 and 766 so as to provide welding therebetween. Simultaneously or separately, electromagnetic pulse source 773 acts as indicated by arrows referenced 781 on facilitating substrate 783 disposed adjacent to protrusions 768 on lower area 762 (of plate 760. Consequently, facilitating substrates 783 are projected towards area 772 of plate 770, against support 709, thereby causing impingement of protrusions 768 against opposing protrusions 778, so as to provide welding therebetween, without causing significant distortion of areas 762 and 772, in contrast to the prior art as disclosed hereinabove in relation to FIG. 4.

Due to the accuracy of the positioning of the electromagnetic impulses 783 and the self-support that develops in the plate stack, there is no need for additional support between plates 760 and 770 since these become internally self-supporting. Only two welded plates are shown but, after welding the first pair, 760 and 770, another plate is added from below and welding is continued as disclosed hereinabove in relation to FIG. 15.

In accordance with an additional embodiment of the present invention, referring now to FIG. 16, there is shown disposed onto base referenced 802 the upper plate referenced 810 and lower plate referenced 820 with edges referenced 816 already electromagnetically impulse welded to edges referenced 826. An additional plate 830, having a facilitating substrate material referenced 800 applied to the upper surface of edges referenced 836, is placed beneath joined plates 810 and 820. There is further indicated the disposition before welding plate 830 to plates 810 and 820, on the left side referenced 801 of FIG. 16, and on the right side 803, after welding. In order to facilitate electromagnetic impulse welding, source referenced 833 is caused to direct electromagnetic impulses towards facilitating substrate 800, as indicated by arrows referenced 852. This causes edges 816 of plate 810 to be accelerated and projected respectively towards edges 826 and then towards edges referenced 836 of plate 830 thereby welding these together. Similarly, protrusions referenced 828 on area referenced 832 are directed to impinge against opposing protrusions referenced 838 on area referenced 832 and thereby to be welded together as shown on the right side 803 of FIG. 16. Similarly, by adding further plates from below, one after another, a plurality of plates are welded together. Welding in the flow area 812, 822, 832, and so on, of protrusions referenced 838 to opposing protrusions 828 is facilitated generally as disclosed hereinabove in relation to FIG. 15.

It will be appreciated by persons skilled in the art that the present invention is not limited by the drawings and description hereinabove presented. Rather, the invention is defined solely by the claims that follow.

1. A heat exchanger stack including at least first and second nestable plates formed of a plate material being substantially unresponsive to electromagnetic impulse welding, and wherein each said plate includes:
a) a generally flat central portion having a plurality of protrusions protruding from at least one surface thereof; and
b) at least one pair of edge portions generally formed non-coplanar relative to said generally flat central portion,
wherein said at least first and second plates are arranged in a nesting arrangement and spaced apart by said protrusions so as to define therebetween a space through which a heat exchange medium may flow,
wherein said at least first and second plates are affixed together by electromagnetic pulse welds at a plurality of welding locations which include said protrusions and said at least one pair of edge portions,
and wherein said at least first and second plates are mutually connected at said welding locations via a facilitator substrate, which is highly responsive to electromagnetic impulse welding, and which is disposed on at least one of said at least first and second plates.

2. A heat exchanger stack in accordance with claim 1, wherein said facilitator substrate is selectively applied to at least one surface of said edge portions of at least one of said at least first and second nestable plates.

3. A heat exchanger stack in accordance with claim 1, wherein said facilitator substrate is selectively applied to at least one surface of said protrusions of said at least first and second nestable plates.

4. A heat exchanger stack in accordance with claim 1, wherein a substrate of a non-conductive material is selectively applied to at least one surface of said edge portions and to said generally flat central portion of at least one of said first and second nestable plates, thereby to provide resistance to electromagnetic impulse welding thereto.

5. A heat exchanger stack including at least first and second nestable plates formed of a plate material being substantially unresponsive to electromagnetic impulse welding, and wherein each said plate includes:
a) a generally flat central portion having a plurality of protrusions protruding from at least one surface thereof; and
b) at least one pair of edge portions generally formed non-coplanar relative to said generally flat central portion,
wherein said at least first and second plates are arranged in a nesting arrangement and spaced apart by said protrusions so as to define therebetween a space through which a heat exchange medium may flow,
wherein said at least first and second plates are affixed together by electromagnetic pulse welds at a plurality of welding locations which include said protrusions and said at least one pair of edge portions,
and wherein said at least first and second plates are mutually connected at said welding locations via an intervening facilitator material, which is highly responsive to electromagnetic impulse welding.

6. A heat exchanger stack in accordance with claim 5, wherein said intervening facilitator material provides a joining medium in said plurality of welding locations.

7. A method for forming a heat exchanger stack from a plurality of heat exchanger plates formed of a plate material being substantially unresponsive to electromagnetic impulse welding, wherein the plurality of plates includes at least first and second nestable plates, each having a generally flat central portion and having at least a pair of edge portions generally non-coplanar relative to the flat central portion of the plate, and wherein each plate is formed so that in a stacked, nested disposition, the generally flat central portions of the plates, having similar protrusions formed on both surfaces thereof, are spaced apart thereby to define therebetween a space through which a heat exchange medium may be passed, the method includes the steps:
a) applying a facilitator substrate, which is highly responsive to electromagnetic impulse welding, to at least one surface of the edge portions and selectively to at least one surface of the generally flat central portion of each plate;
b) disposing the first and second exchanger plates in nesting arrangement on a support; such that the central portions and the edge portions of the two plates are spaced apart; and
c) exposing the facilitator substrate applied to at least one of the first and second heat exchanger plates to a source of electromagnetic impulse energy, so as to apply thereto a kinetic force causing the facilitator substrate to induce the edge portions and selected portions of the flat central portion to bend away from the source of electromagnetic impulse energy, such that the edge portions and the protrusions impinge on the respective edge portions and protrusions of the other plate, so as to become joined thereto.

8. A method according to claim 7 wherein said step of disposing the first and second heat exchanger plates on a support includes disposing at least one heat exchanger plate in supporting contact with a shaped surface defined by the support.

9. A method according to claim 7, wherein said method includes, a step prior to said step a), of:
applying a non-conductive substrate to at least one surface of the edge portions of each plate and to preselected portions adjacent to the protrusions of the generally flat central portions of each plate, which provides resistance to electromagnetic impulse welding thereto.

10. A method for forming a heat exchanger stack from a plurality of plates formed of a plate material being substantially unresponsive to electromagnetic impulse welding, wherein the plurality of plates includes at least first and second nestable plates, each having a generally flat central portion and at least a pair of edge portions generally non-coplanar relative to the central portion of the plate, wherein each plate has a plurality of protrusions which is formed so that, when the plates are in a stacked, nested position, the respective opposing pluralities of protrusions of the first and second plates are disposed in close spaced apart proximity to each other, and that the respective central portions of the plates are spaced apart, thereby to define therebetween a space through which a heat exchange medium may be passed, wherein the method includes:
a) applying a facilitator substrate, which is highly responsive to electromagnetic impulse welding, to at least one surface of the edge portions of each plate and to preselected portions adjacent to the protrusions of the generally flat central portions of each plate;
b) disposing the first and second exchanger plates in nesting arrangement on a support; such that the central portions and the edge portions of the two plates are spaced apart; and
c) exposing the facilitator substrate applied to at least one of the first and second heat exchanger plates to a source of electromagnetic impulse energy, so as to apply thereto a kinetic force causing the facilitator substrate to induce the edge portions and selected portions of the flat central portion to bend away from the source of electromagnetic impulse energy, such that the edge portions and the protrusions impinge on the respective edge portions and protrusions of the other plate, so as to become joined thereto.

11. A method according to claim 10, wherein said step of disposing the first and second heat exchanger plates on a support includes disposing at least one heat exchanger plate in supporting contact with a shaped surface defined by the support.

12. A method in accordance with claim 10, wherein said method includes, a step prior to said step a), of:
applying a non-conductive substrate to at least one surface of the edge portions of each plate and to preselected portions adjacent to the protrusions of the generally flat central portions of each plate, which provides resistance to electromagnetic impulse welding thereto.

13. A method for forming a heat exchanger stack from a plurality of heat exchanger plates formed of a plate material being substantially unresponsive to electromagnetic impulse welding, wherein the plurality of plates includes at least first and second nestable plates, each having a generally flat central portion and having at least a pair of edge portions generally non-coplanar relative to the flat central portion of the plate, and wherein each plate is formed so that in a stacked, nested disposition, the generally flat central portions of the plates, having similar protrusions formed on both surfaces thereof, are spaced apart thereby to define therebetween a space through which a heat exchange medium may be passed, the method includes the steps:
a) applying a facilitator material, which is highly responsive to electromagnetic impulse welding, to at least one surface of the edge portions and selectively to at least one surface of the generally flat central portion of each plate;
b) disposing the first and second exchanger plates in nesting arrangement on a support; such that the central portions and the edge portions of the two plates are spaced apart; and
c) exposing the facilitator applied to at least one of the first and second heat exchanger plates to a source of electromagnetic impulse energy, so as to apply thereto a kinetic force causing the facilitator material to induce the edge portions and selected portions of the flat central portion to bend away from the source of electromagnetic impulse energy, such that the edge portions and the protrusions impinge on the respective edge portions and protrusions of the other plate, so as to become joined thereto by the intervening facilitator material.

14. A method according to claim 13, wherein said step of disposing the first and second heat exchanger plates on a support includes disposing at least one heat exchanger plate in supporting contact with a shaped surface defined by the support.
